(19) United States
(12) Patent Application Publication
(10) Pub. No.: US 2019/0158731 A1
(43) Pub. Date: May 23, 2019

(54) METHOD AND DEVICE FOR CAPTURING A VIDEO WITH A FRONT CAMERA ACCORDING TO AN IMAGE OF THE USER CAPTURED BY A REAR CAMERA

(71) Applicant: THOMSON Licensing, Issy-les-Moulineaux (FR)

(72) Inventors: CLAIRE-HÉLÈNE DEMARTY, MONTREUIL LE GAST (FR); LOUIS CHEVALLIER, LA MEZIERE (FR); PRAVEEN ANIL KULKARNI, Rennes (FR)

(21) Appl. No.: 15/821,068

(22) Filed: Nov. 22, 2017

(51) Int. Cl. H04N 5/232; H04N 5/247; G06F 3/01

(52) U.S. Cl. CPC H04N 5/23219; G06F 3/013; H04N 5/247

(57) ABSTRACT

A method and video capture device is provided having a front camera for capturing images of a front scene initially having an object of interest for the user of the device. A rear camera is also included and configured to capture images of the head of a user of the device. The rear camera also includes a processing circuit to estimate the eye movement of the user and the displacement of the object of interest in the front scene captured from the estimated eye movement of the user. The rear camera further includes a decision making circuit to determine, from the estimated displacement of the object of interest, if the object of interest leaves the captured front scene and, when that is the case triggers an action.

### TECHNICAL FIELD

The present invention relates to the domain of video sequence capturing using capture devices equipped with a front camera and a rear camera.

### PRIOR ART

Mobile phones and tablets are nowadays frequently used to film any type of event, such as for example family meals, marriages, shows and conferences. During the capture, the user generally looks at the screen of his telephone or his tablet to assure himself that the captured scene is well framed and that it clearly shows the people and/or required objects. The user is therefore forced to look at the scene through the screen of the telephone. The result may be a feeling of frustration of not being able to look directly at the scene.

There is therefore a need to help the user to be able to film a scene without having to constantly monitor the screen of the capture device. This need is all the more difficult to meet when the scene comprises elements that move and when the capture must follow these elements.

FIG. 1 diagrammatically illustrates the case of a father P filming with his mobile telephone T the dance event of his daughter F. This father particularly wants to film his daughter. As the figure shows, the father is thus constrained to look at the show through the screen of his telephone to ensure that he does film his daughter. He reorients his telephone as his daughter moves.

### SUMMARY OF THE INVENTION

The invention proposes a solution enabling the user to avoid having to look continuously at the filmed scene through the screen of its video capture device to reorient if necessary the video capture device.

According to the invention, it is considered that the user wants to film what he is viewing. Moreover, the video capture devices, such as mobile phones or tablets, are now, and in a standard manner, equipped with a front camera to film a front scene and rear camera to capture the user, in particular his face, in particular his eyes.

According to the invention, it is therefore proposed to use the back camera of the video capture device to follow the gaze of the user, estimate the displacement of the object, call object of interest, that follows the face of the user and deduce from it if the object of interest is still in the scene captured by the front camera of the device.

More particularly, the invention relates to a video image capture device comprising:
a camera, called front camera, to capture images, called front images, of a front scene initially comprising an object of interest for the user of the device, said object of interest being potentially mobile and able to leave the captured front scene,
a camera, called rear camera, to capture images, called rear images, of a rear scene, said rear camera being configured to capture images of the eyes of a user of the device, forming rear images,
a processing circuit of the rear images to estimate the eye movement of the user and estimate the displacement of the object of interest in the front scene captured from the estimated eye movement of the user, and
a decision making circuit to determine, from the estimated displacement of the object of interest, if the object of interest leaves the captured front scene and, in the affirmative, trigger an action.

According to a particular embodiment, the triggered action is the emission of a sound signal and/or the emission of a vibration.

According to another particular embodiment, the front camera is mounted mobile in said device and the action consists in moving the front camera to modify the shooting axis.

According to another particular embodiment, the device comprises an accelerometer to estimate the movement of the device and the estimated movement of the device is supplied to the processing circuit. The processing circuit then estimates the displacement of the object of interest from the difference between the estimated eye movement and the estimated movement of the device.

The invention also relates to a method for capturing video images comprising the following steps for:
capturing with a camera called front camera, images, called front images, of a front scene initially comprising an object of interest for the user of the device, said object of interest being potentially mobile and able to leave the captured front scene,
capturing, with a camera called rear camera, images, called rear images, of a rear scene, and characterised in that the rear camera is configured to capture images of the eyes of a user, forming the rear images,
   and in that the method further comprises the following steps:
processing the rear images to estimate the eye movement of the user and estimate the displacement of the object of interest in the front scene captured from the estimated eye movement of the user, and
determining, from the estimated displacement of the object of interest, if the object of interest leaves the captured front scene and, in the affirmative, trigger an action.

As mentioned above, the triggered action is the emission of a sound signal and/or the emission of a vibration or else, if the front camera is mobile, the action consists in moving the front camera to modify its shooting axis.

According to another particular embodiment, the method further comprises a step for estimating the movement of the front camera and the rear camera. The movement of the object of interest is then estimated from the difference between the estimated eye movement and the estimated movement of the device.

Other advantages may also occur to those skilled in the art upon reading the examples below, illustrated by the annexed figures, given by way of illustration.

### BRIEF DESCRIPTION OF THE FIGURES

FIG. 1, already described, is a diagrammatic view showing the video capture of a scene with a device according to the prior art,

FIG. 2 is a diagrammatic view showing the video capture of the same scene with a device compliant with the invention,

FIG. 3 is a functional diagram of a video capture device according to an embodiment of the invention, and

FIG. 4 shows a flow chart of the steps of the method according to the invention.

### DETAILED DESCRIPTION OF THE INVENTION

FIG. 2 shows a video capture operation with a video capture device according to the invention. According to the invention, the front camera of the device is used to film the desired scene while the rear camera is used to capture images of the eyes, at least, of the user. An eye movement detection algorithm is then applied on the captured images by the rear camera to estimate the eye movement of the user and to deduce from it the displacement of the object of interest in the scene filmed by the front camera. The user can then position the video capture device outside his field of vision as shown in FIG. 2. The position of the object of interest in the scene filmed by the camera is continually estimated and the user is warned when the object of interest leaves the scene filmed by the front camera.

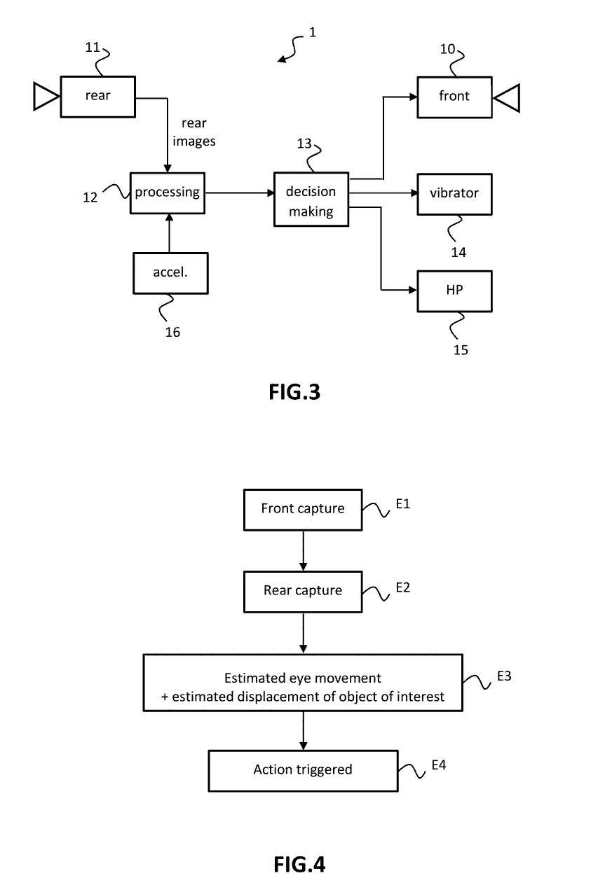

FIG. 3 represents a block diagram of a video capture device 1 compliant with the invention.

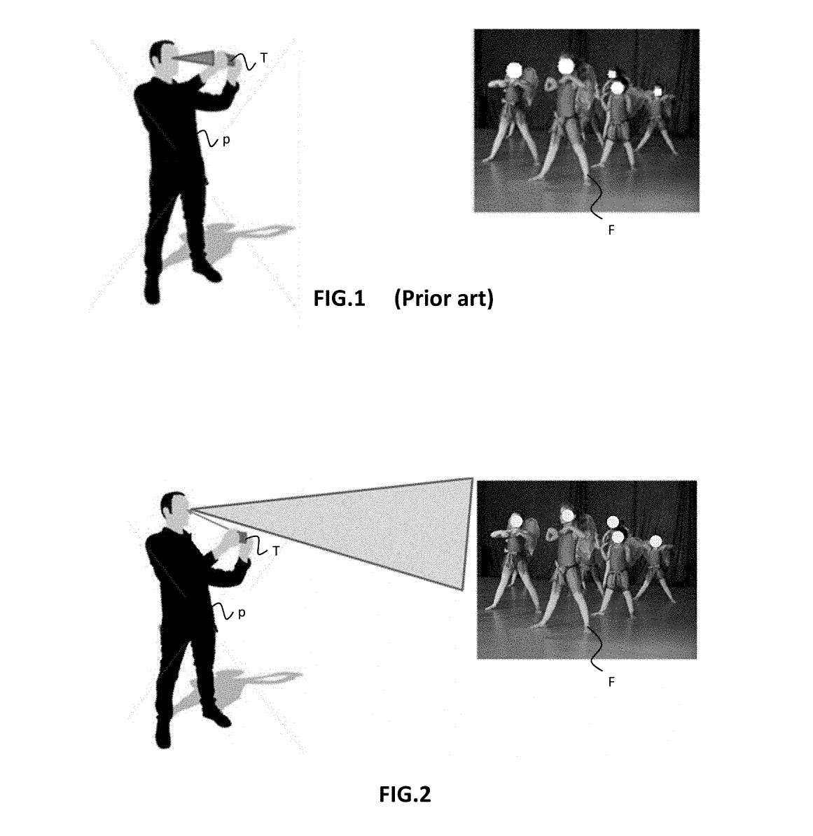

The video capture device 1 comprises a front camera 10 to capture images of a front scene, for example a show as in FIGS. 1 and 2, comprising an object of interest and a rear camera 11 to capture images of a rear scene. The rear camera 11 is more particularly configured to capture images of the eyes of the user of the device. It can capture a wider scene than the eyes of the user, for example their head.

The device 1 also comprises an image processing circuit 12 to process the images captured by the rear camera 11 and a decision making circuit 13. The image processing circuit 12 implements an algorithm for estimating the eye movement of the user and an algorithm for estimating the movement of the object of interest from the estimated eye movement. The decision making circuit 13 then determines, from the estimated displacement of the object of interest, if the object of interest leaves the front scene and, in the affirmative, triggers an action.

This action can be multiple. It can consist in warning the user that the object of interest is leaving the front scene filmed and that he must therefore change the orientation or position of the video capture device to keep the object of interest in the filmed scene. The decision making circuit 13 sends for example a command to a vibrator 14 of the device so that it can begin to vibrate. It can also trigger the emission of a sound signal by a loudspeaker 15. The vibrator 14 and the loudspeaker 15 are an integral part of the capture device. As a variant, the vibrator 14 and the loudspeaker 15 are separate elements from the device so as not to hinder the recording of the video; for example, the vibrator 14 can be integrated into a watch or clothing item and the loudspeaker 15 can be an earpiece. Hence, the vibration and/or sound will not be recorded by the capture device. The action triggered by the decision making circuit 13 corresponds to a representative signal of a vibration intended for the vibrator 14 or to a representative signal of a sound intended for the loudspeaker 15. As a variant, the action triggered by the decision making circuit 13 has several signals intended for several effectors, for example vibrators or loudspeakers.

If the front camera 10 is a mobile mounted camera in the capture device, the action can also consist in moving the front camera to modify its shooting axis and thus keep the object of interest in the filmed scene.

The estimation of the movement of the object of interest in the filmed scene requires a calibration of the image processing circuit 12 and/or the decision making circuit 13, particularly to determine a correspondence parameter (or scale factor) between the eye movement and the displacement of the object of interest in the scene captured by the front camera 10.

According to the invention, it is assumed that the way in which the user holds the video capture device in relation to his head is known by the circuits 12 and 13.

The correspondence factor can thus be determined in the following manner. The user sets the four corners of a frame, real or virtual, in the real scene for a setting, called reference, of the front camera zoom such as the scene captured by the camera corresponds to the frame mentioned above. The rear camera captures the eye movement of the user. This eye movement is estimated in the rear images by an appropriate algorithm, such as the one described in the American application U.S. 20150092983 A1. It can then be deduced that, for this zoom called reference, the estimated eye movement in the rear images corresponds to a displacement of the object of interest on the edge of the scene. More particularly, the eye movement between the upper left corner and the upper right corner corresponds to a movement of the object of interest between the left edge and the right edge of the scene. Likewise, the eye movement between the upper right corner and the lower right corner corresponds to a movement of the object of interest between the upper edge and the lower edge of the scene. From this, a correspondence can thus be deduced between the eye movement and the movement of the object of interest in the scene for the reference zoom.

If you initially consider an object of interest in the centre of the scene filmed and if you detect an eye movement equal to half the estimated movement for a displacement of the object of interest between the left edge and right edge, it can be deduced from this that the object of interest is on the point of leaving the filmed scene.

In operation, the capture device of the invention is used in the following manner.

The user starts the video capture by the front camera. This automatically triggers the capture of images of the eyes of the user by the rear camera.

According to a basic embodiment, the user places the object of interest at the centre of the scene filmed by the front camera. This can determine the initial position of this object in the filmed scene without having to process the front images.

As a variant, the user can select the initial position of the object of interest by pointing it on a touch screen of the capture device displaying the images captured by the front camera.

By supposing that the user follows the object of interest, the movement of their eyes provides information on the displacement of the object of interest. The image processing circuit then estimates the displacement of the object of interest from the estimated eye movement of the user and the zoom factor of the front camera. If the zoom factor used (Z) is different from the reference zoom (Zref), the displacement of the object of interest estimated from the estimated eye movement by the Z/Zref ratio.

When the decision making circuit determines, from the estimated movement of the object of interest, that the latter has reached one edge of the filmed scene, it triggers an alarm, for example the emission of a sound signal and/or a vibration. Advantageously, this alarm is triggered before the object reaches an edge of the scene. It is triggered for example at a predetermined threshold before the object of interest reaches the edge. This threshold distance can vary during the capture and notably depends on the speed of displacement of the object of interest.

The reception of this alarm invites the user to verify the position of the capture device and to reposition himself in relation to the scene if necessary. The user must reposition himself, for example by angularly pivoting on his feet so as to maintain the position of the capture device in relation to his head.

As a variant, the user can be authorised to move the capture device during the video capture. The displacement of the device is then measured, for example with an inertial measurement unit comprising for example one or more accelerometer(s) (such as the accelerometer in FIG. 3) and/or one or more gyroscope(s) and/or a compass and/or a level, embedded into the capture device. As a variant, the displacement of the capture device can be detected by a positioning system external to the capture device, for example an infrared camera network. The processing circuit then estimates the displacement of the object of interest from the difference between the estimated eye movement and the estimated movement of the device and according to the zoom factor applied to the capture device. Advantageously, this variant can correct the errors related to the involuntary displacements of the capture device by the user.

The invention also relates to a video capture method with a capture device comprising a front camera and a rear camera. FIG. 4 illustrates the steps of this method:

According to a first step El, a front scene to film is captured with the front camera of the capture device. The front scene comprises an object of interest that the user wants to see appear in the images throughout the capture.

According to a step E2, the rear camera captures images of the eyes, at least, of the user.

According to a step E3, the rear images of the camera are processed to estimate the eye movement of the user and estimate the displacement of the object of interest in the front scene from the estimated eye movement of the user, and

According to a step E4, it is determined, from the estimated displacement of the object of interest, if the object of interest leaves the captured front scene and, in the affirmative, an alarm is triggered to warn the user.

The invention is described in the preceding text as an example. It is understood that those skilled in the art are capable of producing different embodiment variants of the invention, by combining for example, the different characteristics above taken alone or in combination, without for as much leaving the scope of the invention.

1. Video image capture device (1) comprising:
a camera, called front camera (10), to capture images, called front images, of a front scene initially comprising an object of interest for a user of the device, said object of interest being potentially mobile and able to leave the captured front scene,
a camera, called rear camera (11), to capture images, called rear images, of a rear scene, and
wherein that the rear camera is configured to capture images of the eyes of the user of the device, forming the rear images, and in that the device further comprises
a processing circuit (12) of the rear images to estimate the eye movement of the user and estimate the displacement of the object of interest in the front scene captured from the estimated eye movement of the user, and
decision making circuit (13) to determine, from the estimated displacement of the object of interest, if the object of interest leaves the captured front scene and, in the affirmative, trigger an action.

2. Device according to claim 1, wherein the triggered action is the emission of a sound signal and/or the emission of a vibration.

3. Device according to claim 1, wherein the front camera is mounted mobile in said device and wherein the action consists in moving the front camera to modify the shooting axis.

4. Device according to claim 1 comprising an accelerometer (16) to estimate the movement of the device, wherein the estimated movement of the device is supplied to the decision making circuit and wherein the processing circuit estimates the displacement of the object of interest from the difference between the estimated eye movement and the estimated movement of the device.

5. Method for capturing video images comprising the following steps for:
capturing (E1) with a camera called front camera, images, called front images, of a front scene initially comprising an object of interest for the user of the device, said object of interest being potentially mobile and able to leave the captured front scene,
capturing (E2), with a camera called rear camera, images, called rear images, of a rear scene, and
wherein that the rear camera is configured to capture images of the eyes of the user, forming the rear images,
and in that the method further comprises the following steps:
processing (E3) the rear images to estimate the eye movement of the user and estimate the displacement of the object of interest in the front scene captured from the estimated eye movement of the user, and
determining (E4), from the estimated displacement of the object of interest, if the object of interest leaves the captured front scene and, in the affirmative, trigger an action.

6. Method according to claim 5, wherein the triggered action is the emission of a sound signal and/or the emission of a vibration.

7. Method according to claim 5, wherein the front camera is mounted mobile in said device and wherein the action consists in moving the front camera to modify the shooting axis.

8. Method according to claim 5, further comprising a step for estimating the movement of the front camera and of the rear camera and wherein the displacement of the object of interest is estimated from the difference between the estimated eye movement and the estimated movement of the device.
